(19) United States
(12) Patent Application Publication
(10) Pub. No.: US 2024/0300607 A1
(43) Pub. Date: Sep. 12, 2024

(54) METHOD FOR CONTROLLING A MOTORCYCLE USING A SMART DASHBOARD THEREOF AND A MOBILE DEVICE

(71) Applicant: KWANG YANG MOTOR CO., LTD., Kaohsiung (TW)

(72) Inventor: Yao-Hsien WANG, Kaohsiung (TW)

(21) Appl. No.: 18/598,991

(22) Filed: Mar. 7, 2024

(30) Foreign Application Priority Data
Mar. 9, 2023 (TW) 112108729

(51) Int. Cl. B62J 50/22; B62J 3/14; B62J 6/01; B62J 6/022; B62J 45/20; G06F 3/16; G07C 5/00

(52) U.S. Cl. CPC B62J 50/22; B62J 3/14; B62J 6/01; B62J 6/022; B62J 45/20; G06F 3/167; G07C 5/008

(57) ABSTRACT

A method for controlling a motorcycle using a smart dashboard and a mobile device, the smart dashboard including a wireless connection module, the mobile device including a first communication unit for connecting to the smart dashboard and a second communication unit for connecting to a cloud server, the method includes gathering, by the smart dashboard, information associated with control units of the motorcycle, and storing the information as a control unit dataset; establishing, by the first communication unit, a communication with the wireless connection module; transmitting, by the smart dashboard, the control unit dataset to the first communication unit; and transmitting, by the second communication unit, the control unit dataset to the cloud server.

### CROSS-REFERENCE TO RELATED APPLICATION

This application claims priority to Taiwanese Invention Application No. 112108729, filed on Mar. 9, 2023, and incorporated by reference herein in its entirety.

### FIELD

The disclosure relates to a method for controlling a motorcycle using a smart dashboard thereof and a mobile device.

### BACKGROUND

As the fields of data analysis and data communication advance, a wide variety of applications involving different devices have emerged. For example, vehicle data associated with a conventional motorcycle may be uploaded onto a server for analysis. As such, a motorcycle may be equipped with a dashboard for displaying the vehicle data, a first processing unit for controlling the dashboard to display the vehicle data, and a communication control unit (CCU) that includes a communication module supporting a wireless communication and a second processor for controlling the communication module to upload the vehicle data onto the server.

It is noted that, since the CCU may not be a built-in component for some of the motorcycles (e.g., the older models), in order to implement the above functions for those motorcycles, an additional CCU may need to be installed, thereby increasing the related cost.

### SUMMARY

Therefore, one object of the disclosure is to provide a method for a motorcycle using a smart dashboard thereof and a mobile device.

According to one embodiment of the disclosure, the method for controlling a motorcycle using a smart dashboard thereof and a mobile device is provided. The smart dashboard includes a wireless connection module. The mobile device includes a first communication unit for connecting to the smart dashboard and a second communication unit for connecting to a cloud server. The method includes:
a) gathering, by the smart dashboard, information associated with a plurality of control units of the motorcycle, and storing the information as a control unit dataset in a storage module;
b) establishing, by the first communication unit, a communication between the first communication unit and the wireless connection module;
c) transmitting, by the smart dashboard, the control unit dataset to the first communication unit via the wireless connection module; and
d) in response to receipt of the control unit dataset, transmitting, by the second communication unit, the control unit dataset to the cloud server.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components included in a vehicle, a mobile device, and a cloud server according to one embodiment of the disclosure.

FIG. 2 is a flow chart illustrating steps of a method for controlling the motorcycle using the smart dashboard and the mobile device as shown in FIG. 1 according to one embodiment of the disclosure.

FIG. 3 is a flow chart illustrating steps of a method for controlling the motorcycle using the smart dashboard and the mobile device as shown in FIG. 1 according to one embodiment of the disclosure.

FIG. 4 is a flow chart illustrating steps of a method for controlling the motorcycle using the smart dashboard and the mobile device as shown in FIG. 1 according to one embodiment of the disclosure.

FIG. 5 is a flow chart illustrating steps of a method for controlling the motorcycle using the smart dashboard and the mobile device as shown in FIG. 1 according to one embodiment of the disclosure.

FIG. 6 is a flow chart illustrating steps of a method for controlling the motorcycle using the smart dashboard and the mobile device as shown in FIG. 1 according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

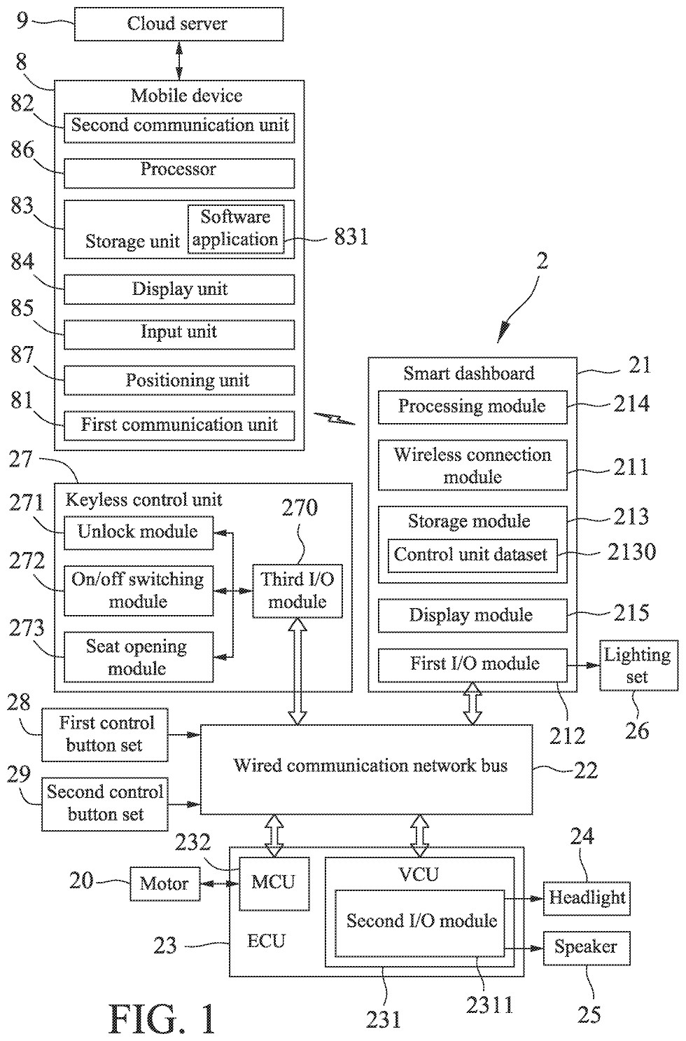

FIG. 1 is a block diagram illustrating components included in a vehicle, a mobile device 8, and a cloud server 9 according to one embodiment of the disclosure. In some embodiments, the vehicle may be embodied using a motorcycle 2. The motorcycle 2 includes a motor 20, a smart dashboard 21, a wired communication network bus 22, an electronic control unit (ECU) 23, a headlight 24, a speaker 25, a lighting set 26, a keyless control unit 27, a first control button set 28, and a second control button set 29. It is noted that in the embodiment of FIG. 1, the motorcycle includes a plurality of control units (i.e., the ECU 23 and the keyless control unit 27), but in other embodiments, additional control units may be built into the motorcycle 2.

The smart dashboard 21 is disposed to be able to be viewed by a user of the motorcycle 2, and includes a wireless connection module 211, a first input/output (I/O) module 212, a storage module 213, a processing module 214, and a display module 215.

In some embodiments, the wireless connection module 211 may be embodied using components that enable a wireless connection. Specifically, in this embodiment, the wireless connection module 211 is embodied using a Bluetooth® component.

The first I/O module 212 is connected to the lighting set 26 and the wired communication network bus 22, and is configured to transmit data thereto.

The storage module 213 may be embodied using, for example, random access memory (RAM), read only memory (ROM), programmable ROM (PROM), firmware, flash memory, etc. In this embodiment, the storage module 213 stores a software application therein.

The display module 215 may be embodied using a liquid crystal display (LCD) screen or other suitable display screens.

The processing module 214 is connected to the wireless connection module 211, the first I/O module 212, the storage module 213 and the display module 215, and may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. In use, the processing module 214 is configured to execute the software application stored in the storage module 213 so as to implement the operations as described below.

The wired communication network bus 22 interconnects the smart dashboard 21, the ECU 23, the keyless control unit 27, the first control button set 28, and the second control button set 29. In some embodiments, the wired communication network bus 22 may be embodied using a controller area network (CAN) bus, but is not limited to such.

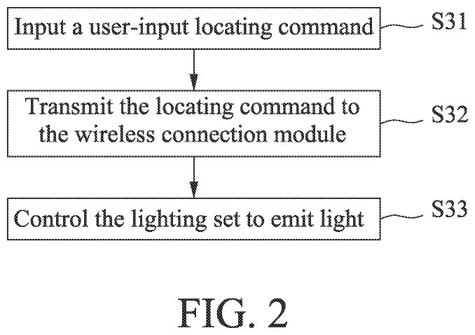

The ECU 23 includes a plurality of control units. In the embodiment of FIG. 2, the ECU 23 includes a vehicle control unit (VCU) 231 and a motor control unit (MCU) 232. The VCU 231 is connected to the wired communication network bus 22, includes components that are similar to those of the processing module 214, and further includes a second I/O module 2311 that is connected to the headlight 24 and the speaker 25 for enabling the VCU 231 to control the operations thereof. In some embodiments, the VCU 231 may be connected to the wired communication network bus 22 by means of the second I/O module 2311. The MCU 232 is connected to the motor 20 for controlling the operations thereof. It is noted that the controlling of the motor 20, the headlight 24, and the speaker 25 is well known in the related art, and details thereof are omitted herein for the sake of brevity.

The lighting set 26 typically includes a number of brake light, a front pair of turn signals, and a back pair of turn signals.

The keyless control unit 27 includes a third I/O module 270 that is connected to the wired communication network bus 22, and a number of sub-modules that are connected to the third I/O module 270 and that are for enabling a user (e.g., a rider of the motorcycle 2) to control the operations of the motorcycle 2. In the embodiment of FIG. 1, the sub-modules include an unlock module 271, an on/off switching module 272, and a seat opening module 273. The unlock module 271 may include a microprocessor, and a near field communication (NFC) antenna that is configured to detect presence of an electronic key nearby. The electronic key may include an electronic chip including information therein that may be detected by the NFC antenna. When the presence of the electronic key is detected by the (NFC) antenna, the microprocessor of the unlock module 271, after verifying the electronic key, transmits a lock control signal to a lock mechanism (e.g., a mechanical lock or an electromagnetic lock) such that a steering handle (not depicted in the drawings) of the motorcycle 2 is switched between a locked state, in which the steering handle cannot be operated, and an unlocked state, in which steering handle can be operated. The on/off switching module 272 is connected to the NFC antenna of the unlock module 271, and may include a microprocessor that is configured to determine, based on the information detected by the NFC antenna, whether the electronic key matches the motorcycle 2. In the case where the electronic key matches the motorcycle 2 (i.e., the electronic key is verified), the on/off switching module 272 may transmit an on/off signal to the ECU 23 so as to power on the motorcycle 2 (i.e., starting the motor 20) or power off the motorcycle 2 (i.e., stopping the motor 20). It is noted that after powering on the motorcycle 2, the motorcycle 2 may be said to be in a Key ON state, and after powering off the motorcycle 2, the motorcycle 2 may be said to be in a Key OFF state. The seat opening module 273 may include a microprocessor, and a solenoid valve that is connected to an engage mechanism of the motorcycle 2 that secures a seat on a chassis of the motorcycle 2. In response to receipt of an opening signal to “open” the seat, the microprocessor controls the solenoid valve to disengage the engage mechanism. As a result, one side of the seat pops up, exposing a storage compartment below the seat.

In the embodiment of FIG. 1, the first control button set 28 may include a button for powering on the motorcycle 2, a button for powering off the motorcycle 2, and a button to “open” the seat (i.e., to disengage the engage mechanism that secures the seat).

The second control button set 29 may include a button for locking and unlocking the steering handle of the motorcycle 2. It is noted that in other embodiments, additional buttons may be present to enable additional functions for the user.

In some embodiments, the motorcycle 2 may include a keyhole (not depicted in the drawings) for insertion of a key so as to enable the user to lock/unlock the steering handle, and to power on/off the motorcycle 2. In some embodiments, the keyless control unit 27 of the motorcycle 2 may include a sensor module (not depicted in the drawings) for detecting the presence of a keyless component that serves a physical key. After the sensor module detects the keyless component, the user may operate the first control button set 28 and a second control button set 29 to lock/unlock the steering handle, power on/off the motorcycle 2, or disengage the engage mechanism.

The mobile device 8 may be embodied using a smartphone, a tablet, or other similar electronic devices, and includes a first communication unit 81, a second communication unit 82, a storage unit 83, a display unit 84, an input unit 85, a processor 86, and a positioning unit 87.

The first communication unit 81 is configured to communicate with the wireless connection module 211 of the smart dashboard 21. As such, in this embodiment, the first communication unit 81 may also include a Bluetooth® component. That is to say, each of the wireless connection module 211 of the smart dashboard 21 and the first communication unit 81 includes a Bluetooth® component, and the communication between the first communication unit 81 and the wireless connection module 211 is a Bluetooth® communication.

In other embodiments, each of the wireless connection module 211 of the smart dashboard 21 and the first communication unit 81 may include a short-range wireless communication module supporting a short-range wireless communication network using a wireless technology of Wi-Fi, etc.

The second communication unit 82 includes one or more of a radio-frequency integrated circuit (RFIC), and a mobile communication module supporting telecommunication using Long-Term Evolution (LTE), the third generation (3G), the fourth generation (4G) or the fifth generation (5G) of wireless mobile telecommunications technology, or the like. In use, the second communication unit 82 is configured to communicate with the cloud server 9.

The storage unit 83 may be embodied using components that are similar to those of the storage module 213, and stores a software application 831 therein. The software application 831 includes instructions that, when executed by the processor 86, cause the processor 86 to perform the operations as described below.

The display 84 may be embodied using a display screen that is similar to that of the display module 215. The input unit 85 may include buttons for allowing the user to operate the mobile device 8. In some embodiments, the display 84 and the input unit 85 are integrated using a touch screen.

The processor 86 may be embodied using components that are similar to those of the processor module 214, and is connected to the first communication unit 81, the second communication unit 82, the storage unit 83, the display 84, the input unit 85, and the positioning unit 87. In use, the processor 86 executing the software application 831 is configured to control the operations of the components of the mobile device 8.

The positioning unit 87 may be embodied using a global positioning system (GPS) component.

FIG. 2 is a flow chart illustrating steps of a method for controlling the motorcycle 2 using the smart dashboard 21 and the mobile device 8 as shown in FIG. 1 according to one embodiment of the disclosure.

In use, the mobile device 8 may be hold by the user of the motorcycle 2, and the user is enabled to operate the smart dashboard 21 and the mobile device 8 to implement the method. For example, the user may operate the mobile device 8 to execute the software application 831, which may cause the processor 86 to control the display 84 to display a graphic user interface (GUI) that includes a number of functions related to control of the motorcycle 2. As a result, the user is enabled to input one or more controlling commands via the input module 85 of the mobile device 8.

In the embodiment of FIG. 2, the user may be in a parking lot with a plurality of motorcycles present, and intends to locate the motorcycle 2 that is among the plurality of motorcycles and that is nearby. As such, in step S31, the user operates the mobile device 8 to input a user-input locating command.

In response to receipt of the locating command, in step S32, the processor 86 controls the first communication unit 81 to transmit the locating command to the wireless connection module 211. It is noted that in this embodiment, the first communication unit 81 of the mobile device 8 has been paired with the wireless connection module 211 of the smart dashboard 21, and the first communication unit 81 may automatically establish a communication with the wireless connection module 211 when the mobile device 8 comes within a communication range that enables a communication between the first communication unit 81 and the wireless connection module 211 (e.g., 10 meters). Alternatively, the first communication unit 81 may automatically establish a communication with the wireless connection module 211 after the locating command is inputted by the user.

In response to receipt of the locating command, in step S33, the processing module 214 of the smart dashboard 2 transmits an activation signal via the first I/O module 212 to the lighting set 26, so as to control one or more of the components included in the lighting set 26 to emit light (e.g., the front pair of turn signals and the back pair of turn signals may be controlled to flash yellow lights, but it is not limited to such). As a result, the user may be aware of the location of the motorcycle 2.

It is noted that, in the embodiment of FIG. 2, the motorcycle 2 is parked and is typically in the Key OFF state (e.g., the motor 2 is not running). As a result, in the embodiment of FIG. 1, the lighting set 26 is connected to the smart dashboard 21 instead of the VCU 231 of the ECU 23, as the smart dashboard 21 consumes relatively less power than the ECU 23 and is still powered by a battery (not shown) of the motorcycle 2 even though the motorcycle 2 is in the Key OFF state.

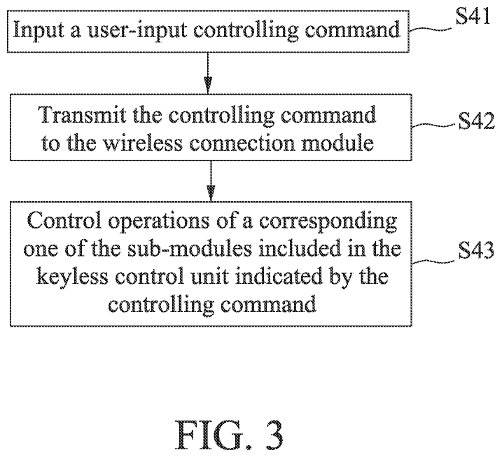

FIG. 3 is a flow chart illustrating steps of a method for controlling the motorcycle 2 using the smart dashboard 21 and the mobile device 8 as shown in FIG. 1 according to one embodiment of the disclosure.

In the embodiment of FIG. 3, the user may intend to perform specific operations related to the motorcycle 2. As a result, in step S41, the user operates the mobile device 8 to input a user-input controlling command. In the embodiment of FIG. 3, the controlling command may be one of an unlocking command to unlock the steering handle of the motorcycle 2, an activation/deactivation command for activating or deactivating the motorcycle 2, and a disengaging command to disengage the engage mechanism that secures the seat so as to expose the storage compartment below the seat, but other controlling command(s) may be available in other embodiments.

In response to receipt of the controlling command, in step S42, the processor 86 controls the first communication unit 81 to transmit the controlling command to the wireless connection module 211. It is noted that in this embodiment, the first communication unit 81 of the mobile device 8 has been paired with the wireless connection module 211 of the smart dashboard 21, and the first communication unit 81 may automatically establish a communication with the wireless connection module 211 when the mobile device 8 comes within the communication range. Alternatively, the first communication unit 81 may automatically establish a communication with the wireless connection module 211 after the controlling command is inputted by the user.

In response to receipt of the controlling command (i.e., one of the unlocking command, the activation/deactivation command, and the disengaging command), in step S43, the processing module 214 of the smart dashboard 2 transmits a controlling signal to the third I/O module 270 via the first I/O module 212 and the wired communication network bus 22, so as to control operations of a corresponding one of the sub-modules included in the keyless control unit 27 indicated by the controlling command (i.e., one of the sensing unlock module 271, the on/off switching module 272, and the seat opening module 273) to perform the intended actions such as unlocking the steering handle of the motorcycle 2 (by the sensing unlock module 271), powering on or off the motorcycle 2 (by the on/off switching module 272) or disengaging the engage mechanism (by the seat opening module 273). As such, the controlling operations of the motorcycle 2 may be implemented using the mobile device 8 and the smart dashboard 21.

It is noted that in some embodiments, the motorcycle 2 is configured that the controlling operations may be also done in a relatively conventional manner. For example, the user may bring the keyless component near the sensor module of the keyless control unit 27, and subsequently the user may to press the first control button set 28 and the second control button set 29 to implement the corresponding controlling operation(s).

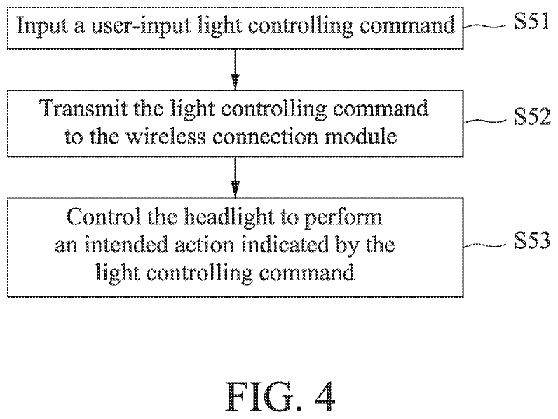

FIG. 4 is a flow chart illustrating steps of a method for controlling the motorcycle 2 using the smart dashboard 21 and the mobile device 8 as shown in FIG. 1 according to one embodiment of the disclosure.

In the embodiment of FIG. 4, the user may intend to perform specific operations related to lighting of the headlight 24 of the motorcycle 2. As a result, in step S51, the user operates the mobile device 8 to input a user-input light controlling command. In the embodiment of FIG. 4, the light controlling command may be one of a delayed turn-off command to cause the headlight 24 to turn off after a delay period, and an adjusting command to adjust light emitted by the headlight 24. It is noted that the delay period and specific characteristics of the light to be emitted by the headlight 24 (e.g., brightness, color temperature, etc.) may be determined by the user operating the mobile device 8. In other embodiments, additional light controlling command(s) may be available.

In response to receipt of the light controlling command, in step S52, the processor 86 controls the first communication unit 81 to transmit the light controlling command to the wireless connection module 211. It is noted that in this embodiment, the first communication unit 81 of the mobile device 8 has been paired with the wireless connection module 211 of the smart dashboard 21, and the first communication unit 81 may automatically establish a communication with the wireless connection module 211 when the mobile device 8 comes within the communication range. Alternatively, the first communication unit 81 may automatically establish a communication with the wireless connection module 211 after the light controlling command is inputted by the user.

In response to receipt of the light controlling command (i.e., one of the delayed turn-off command and the adjusting command), in step S53, the processing module 214 of the smart dashboard 2 transmits a controlling signal to the VCU 231 of the ECU 23 via the first I/O module 212 and the wired communication network bus 22, and the VCU 231 in turn transmits the controlling signal to the headlight 24 via the second I/O module 2311, so as to control the headlight 24 to perform an intended action indicated by the light controlling command such as turning off after the delay period or emitting light as indicated by the adjusting command. As such, the controlling of the headlight 24 may be implemented using the mobile device 8 and the smart dashboard 21.

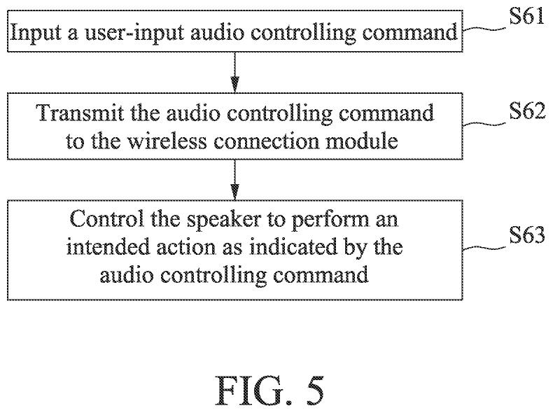

FIG. 5 is a flow chart illustrating steps of a method for controlling the motorcycle 2 using the smart dashboard 21 and the mobile device 8 as shown in FIG. 1 according to one embodiment of the disclosure.

In the embodiment of FIG. 5, the user may intend to perform specific operations related to audio outputted by the speaker of the motorcycle 2. As a result, in step S61, the user operates the mobile device 8 to input a user-input audio controlling command. In the embodiment of FIG. 5, the audio controlling command may be one of an acoustic alert setting command to setup an acoustic warning sound to be outputted by the speaker 25 in specific conditions (e.g., when the motorcycle 2 is an electrical vehicle (EV), the acoustic warning sound may be required when the motorcycle 2 is ridden at a low speed), and an audio adjusting command to adjust specific characteristics of the audio outputted by the speaker 25 (e.g., intensity, tone, etc.). In other embodiments, additional audio controlling command(s) may be available.

In response to receipt of the audio controlling command, in step S62, the processor 86 controls the first communication unit 81 to transmit the audio controlling command to the wireless connection module 211. It is noted that in this embodiment, the first communication unit 81 of the mobile device 8 has been paired with the wireless connection module 211 of the smart dashboard 21, and the first communication unit 81 may automatically establish a communication with the wireless connection module 211 when the mobile device 8 comes within the communication range. Alternatively, the first communication unit 81 may automatically establish a communication with the wireless connection module 211 after the audio controlling command is inputted by the user.

In response to receipt of the audio controlling command (i.e., one of the acoustic alert setting command and the audio adjusting command), in step S63, the processing module 214 of the smart dashboard 2 transmits a controlling signal to the VCU 231 of the ECU 23 via the first I/O module 212 and the wired communication network bus 22, and the VCU 231 in turn transmits the controlling signal to the speaker 25 via the second I/O module 2311, so as to control the speaker 25 to perform an intended action as indicated by the audio controlling command (e.g., to output the acoustic warning sound as indicated). As such, the controlling of the speaker 25 may be implemented using the mobile device 8 and the smart dashboard 21.

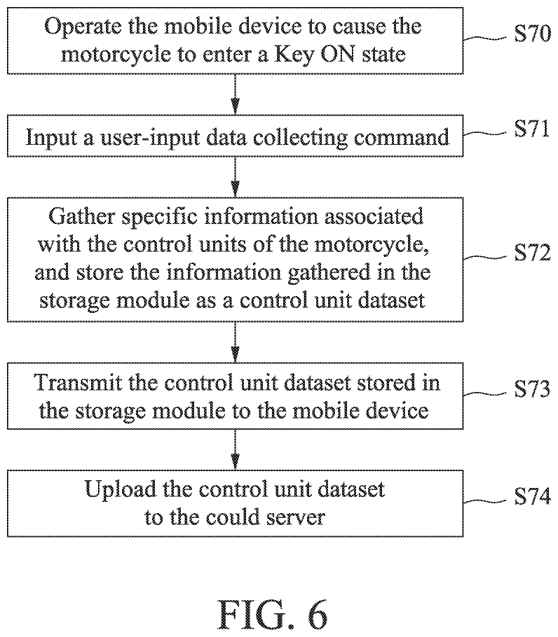

FIG. 6 is a flow chart illustrating steps of a method for controlling the motorcycle 2 using the smart dashboard 21 and the mobile device 8 as shown in FIG. 1 according to one embodiment of the disclosure.

In the embodiment of FIG. 6, the user may intend to upload data related to the motorcycle 2 onto the cloud server 9 for special purposes (e.g., data analysis, troubleshooting, etc.). As a result, in step S70, the user operates the mobile device 8 to cause the motorcycle 2 to enter the Key ON state. In embodiments, the operation of step S70 may be similar to those as depicted in the method of FIG. 3. That is to say, the user operates the mobile device 8 to transmit the activation command to the smart dashboard 21, which in turn causes the on/off switching module 272 to power on the motorcycle 2.

Then, in step S71, in the embodiment of FIG. 6, the user operates the mobile device 8 to input a user-input data collecting command, and the processor 86 controls the first communication unit 81 to transmit the data collecting command to the smart dashboard 21.

In response to receipt of the data collecting command, in step S72, the processing module 214 gathers specific information associated with the control units of the motorcycle 2 (i.e., the ECU 23 and the keyless control unit 27) via the first I/O module 212, the wired network communication bus 22, and the third I/O module 270, and stores the information gathered from the ECU 23 and the keyless control unit 27 in the storage module 213 as a control unit dataset 2130. That is to say, information associated with some or all of the components included in each of the ECU 23 (e.g., one or both of the VCU 231 and the MCU 232) and the keyless control unit 27 (e.g., one or any combination of the sensing unlock module 271, the on/off switching module 272, and the seat opening module 273) may be gathered by the processing module 214.

It is noted that in some embodiments, after the motorcycle 2 enters the Key ON state, the operations of step S72 are automatically implemented, and therefore the operations of step S71 may be omitted.

Then, in step S73, the processing module 214 transmits the control unit dataset 2130 stored in the storage module 213 to the mobile device 8. It is noted that in the embodiments where operations of step S71 are omitted, the user may first make sure that a communication between the first communication unit 81 and the wireless connection module 211 has been established.

In response to receipt of the control unit dataset 2130, in step S74, the processor 86 controls the second communication unit 82 to upload the control unit dataset 2130 to the could server 9. As such, provision of the specific information associated with the control units of the motorcycle 2 to the cloud server 9 may be implemented using the mobile device 8 and the smart dashboard 21. It is noted that the control unit dataset 2130 may be utilized by the cloud server 9 for the purposes of data analysis and/or troubleshooting.

It is noted that in some embodiments, while the motorcycle 2 is in the Key ON state, the processing module 214 automatically gathers the specific information from the ECU 23 and the keyless control unit 27 periodically, so as to store another control unit dataset 2130 in the storage module 213. As such, the control unit dataset 2130 stored in the storage module 213 may be transmitted to the mobile device 8 (i.e., step S73) during a period when the processing module 214 gathers specific information and stores the another control unit dataset 2130 in the storage module 213 (i.e., step S72).

Moreover, each of the control unit datasets 2130 may further include a timestamp indicating a time instance that the specific information are gathered. In embodiments, the storage module 213 of the smart dashboard 21 may have a limited storage capacity (i.e., may simultaneously store a specific number of control unit datasets 2130 therein). In the case where no data collecting command is received from the mobile device 8, or in the case where data transmission between the smart dashboard 21 and the mobile device 8 is slow (e.g., a data transmission rate being lower than a rate of the control unit datasets 2130 filling up the storage module 213), the storage module 213 may become full after the specific number of control unit datasets 2130 are stored therein. As a result, the processing module 214 may store a latest one of the control unit datasets 2130 to overwrite an oldest one of the control unit datasets 2130 that is stored in the storage module 213. Then, when the data collecting command is received or when the data transmission between the smart dashboard 21 and the mobile device 8 becomes normal, the processing module 214 may proceed to transmit the oldest one of the control unit datasets 2130 currently stored in the storage module 213 to the mobile device 8.

To sum up, embodiments of the disclosure provide a method for controlling a motorcycle using a smart dashboard thereof and a mobile device. The method as described above includes at least the following effects.

(1) The smart dashboard 21 and the mobile device 8 may be configured to establish a wireless communication (which may be a short range communication such as Bluetooth®), and therefore the control unit dataset 2130 stored in the storage module 213 may be uploaded to the cloud server 9 for the purposes of data analysis and/or troubleshooting without the need to install on the smart dashboard 21 an additional communication control unit (CCU) that supports suitable communications with the cloud server 9. As such, the cost of manufacturing the smart dashboard 21 may be reduced.

(2) Using the mobile device 8 that executes the software application 831, the user is enabled to locate the motorcycle 2 by inputting a locating command which is then transmitted to the wireless connection module 211. In response to receipt of the locating command, the processing module 214 of the smart dashboard 2 transmits an activation signal to the lighting set 26, so as to control one or more of the components included in the lighting set 26 to flash lights. As a result, the user may be aware of the location of the motorcycle 2 while the motorcycle 2 is in the Key OFF state.

(3) Using the mobile device 8 that executes the software application 831, the user is enabled to perform specific operations related to the motorcycle 2 by inputting a controlling command which is then transmitted to the smart dashboard 21. In embodiments, the controlling command may be one of an unlocking command to unlock the steering handle of the motorcycle 2, an activation/deactivation command for activating or deactivating the motorcycle 2, and a disengaging command to disengage an engage mechanism that secures the seat so as to expose a storage compartment below the seat. In response to receipt of the controlling command, the processing module 214 of the smart dashboard 21 transmits a controlling signal to the third I/O module 270 via the first I/O module 212 and the wired communication network bus 22, so as to control operations of a corresponding one of the sub-modules included in the keyless control unit 27 (i.e., one of the sensing unlock module 271, the on/off switching module 272, and the seat opening module 273) to perform the intended actions. As such, the controlling operations of the motorcycle 2 may be implemented using the mobile device 8 and the smart dashboard 21.

(4) Using the mobile device 8 that executes the software application 831, the user is enabled to perform specific operations related to lighting of the headlight 24 of the motorcycle 2 by inputting a light controlling command which is then transmitted to the wireless connection module 211 of the smart dashboard 2. In response to receipt of the light controlling command, the processing module 214 of the smart dashboard 2 transmits a controlling signal to the VCU 231 via the first I/O module 212 and the wired communication network bus 22, and in turn, the VCU 231 controls the headlight 24 to perform the intended actions such as turning off after the delay period or emitting light as indicated by the controlling command. As such, the controlling of the headlight 24 may be implemented using the mobile device 8 and the smart dashboard 21.

(5) Using the mobile device 8 that executes the software application 831, the user may be enabled to perform specific operations related to audio outputted by the speaker 25 of the motorcycle 2 by inputting an audio controlling command which is then transmitted to the smart dashboard 21. In response to receipt of the audio controlling command, the processing module 214 of the smart dashboard 2 transmits a controlling signal to the VCU 231 via the first I/O module 212 and the wired communication network bus 22, and in turn, the VCU 231 controls the speaker 25 to perform the intended actions as indicated by the audio controlling command. As such, the controlling of the speaker 25 may be implemented using the mobile device 8 and the smart dashboard 21.

It is noted that in some embodiments, different methods as described in FIGS. 2 to 6 may be implemented together in an arbitrary order. For example, the user may first implement the method of FIG. 2 to locate the motorcycle 2, then implement the method of FIG. 3 to open the seat so as to retrieve a helmet placed in the storage compartment, and finally implement the method of FIG. 6 to upload the control unit dataset 2130.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for controlling a motorcycle using a smart dashboard thereof and a mobile device, the smart dashboard including a wireless connection module, the mobile device including a first communication unit for connecting to the smart dashboard and a second communication unit for connecting to a cloud server, the method comprising:
a) gathering, by the smart dashboard, information associated with a plurality of control units of the motorcycle, and storing the information as a control unit dataset in a storage module, wherein, the smart dashboard includes a first input/output (I/O) module connected to a wired communication network bus of the motorcycle, and gathers the information from each of the control units of the motorcycle via the first I/O module and the wired communication network bus;
b) establishing, by the first communication unit, a communication between the first communication unit and the wireless connection module;
c) transmitting, by the smart dashboard, the control unit dataset to the first communication unit via the wireless connection module; and
d) in response to receipt of the control unit dataset, transmitting, by the second communication unit, the control unit dataset to the cloud server.

2. The method as claimed in claim 1, each of the wireless connection module of the smart dashboard and the first communication unit of the mobile device including a Bluetooth® component, wherein in step b), the communication between the first communication unit and the wireless connection module is a Bluetooth® communication.

3. The method as claimed in claim 1, wherein the wired communication network bus is a controller area network (CAN) bus.

4. The method as claimed in claim 1, the control units including an electronic control unit (ECU) and a keyless control unit, wherein the control unit dataset includes information associated with the ECU and the keyless control unit.

5. The method as claimed in claim 4, the ECU including a vehicle control unit (VCU) connected to the wired communication network bus, and a motor control unit (MCU), wherein the control unit dataset includes information associated with the VCU and the MCU.

6. The method as claimed in claim 5, the motorcycle further including a lighting set that is connected to the first I/O module of the smart dashboard, the method further comprising:
in response to receipt of a user-input locating command, transmitting, by the mobile device, the locating command to the wireless connection module; and
in response to receipt of the locating command, controlling, by the smart dashboard, the lighting set to emit light.

7. The method as claimed in claim 5, the keyless control unit including an I/O module connected to the wired communication network bus, a sensing unlock module, an on/off switching module and a seat opening module, the method further comprising:
in response to receipt of a user-input controlling command associated with controlling the operations of one of the sensing unlock module, the on/off switching module and the seat opening module, transmitting, by the mobile device, the controlling command to the wireless connection module; and
in response to receipt of the controlling command, controlling, by a processing module of the smart dashboard, operations of a corresponding one of the sensing unlock module, the on/off switching module and the seat opening module indicated by the controlling command.

8. The method as claimed in claim 5, the motorcycle further including a headlight, the VCU including a second I/O module that is connected to the wired communication network bus and the head light, the method further comprising:
in response to receipt of a user-input light controlling command, transmitting, by the mobile device, the light controlling command to the wireless connection module, the light controlling command being one of a delayed turn-off command to cause the headlight to turn off after a delay period, and an adjusting command to adjust light emitted by the headlight; and
in response to receipt of the light controlling command, controlling, by a processing module of the smart dashboard via the wired communication network bus and the second I/O module, the headlight to perform an intended action indicated by the light controlling command.

9. The method as claimed in claim 5, the motorcycle further including a speaker, the VCU including a second I/O module that is connected to the wired communication network bus and the speaker, the method further comprising:
in response to receipt of a user-input audio controlling command, transmitting, by the mobile device, the audio controlling command to the wireless connection module, the audio controlling command being one of an acoustic alert setting command to setup an acoustic warning sound to be outputted by the speaker in specific conditions, and an audio adjusting command to adjust specific characteristics of the audio outputted by the speaker; and
in response to receipt of the audio controlling command, controlling, by a processing module of the smart dashboard via the wired communication network bus and the second I/O module, the speaker to perform an intended action indicated by the audio controlling command.

10. The method as claimed in claim 1, wherein step a) is implemented periodically, and step c) is implemented during one implementation of step a).
